(19) United States
(12) Patent Application Publication
(10) Pub. No.: US 2016/0364741 A1
(43) Pub. Date: Dec. 15, 2016

(54) REWARDING TRUSTED PERSONS BASED ON A PRODUCT PURCHASE

(71) Applicant: eBay Inc., San Jose, CA (US)

(72) Inventor: Kamal Zamer, Austin, TX (US)

(21) Appl. No.: 14/734,383

(22) Filed: Jun. 9, 2015

(51) Int. Cl. G06Q 30/02; G06Q 50/00

(52) U.S. Cl. CPC G06Q 30/0214; G06Q 50/01

(57) ABSTRACT

In various example embodiments, a system and method for rewarding trusted persons based on a product purchase. In one embodiment, a system includes a trust module that determines one or more trusted persons, a pre-purchase module to record interactions between the potential purchaser and the trusted persons, a purchase module to determine that the potential purchaser purchased a product, and a reward module to determine one of the trusted persons that recommended the product to the potential purchaser in an interaction stored in the log, the reward module rewarding the trusted person that recommended the product to the potential purchaser.

### TECHNICAL FIELD

Embodiments of the present disclosure relate generally to product sales and marketing and, more particularly, but not by way of limitation, to rewarding trusted persons based on a product purchase.

### BACKGROUND

People purchase products for a wide variety of different reasons and it can be difficult to ascertain why the user purchased a specific product. In many scenarios, people consider the opinions and/or insight of trusted persons to determine which product to purchase. However, determining how the trusted persons influenced the purchaser can be equally challenging.

Conventionally, users place a higher value for recommendations from people they trust. This is especially the case when a recommendation is given in a natural scenario where the person offers the recommendation without ulterior motives.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is an illustration depicting one scenario for determining a trusted person, according to one example embodiment.

FIG. 3 is an illustration depicting another scenario for determining a trusted person, according to one example embodiment.

FIG. 4 is a block diagram illustrating a system for rewarding trusted persons based on a product purchase, according to one example embodiment.

FIG. 5 is a block diagram illustrating data flow for a system that rewards trusted persons based on a product purchase, according to one example embodiment.

FIG. 6 is a trusted person log, according to one example embodiment.

FIG. 7 is a recommendation log, according to one example embodiment.

FIG. 8 is flow diagram illustrating a method for rewarding trusted persons based on a product purchase, according to one example embodiment.

FIG. 9 is a flow diagram illustrating another method for rewarding a trusted person based on a product purchase, according to one example embodiment.

FIG. 10 is a flow diagram illustrating a method for rewarding many trusted persons based on a product purchase, according to one example embodiment.

FIG. 11 is a flow diagram illustrating another method for rewarding a trusted person based on a product purchase, according to an example embodiment.

FIG. 12 is a flow diagram illustrating one method for rewarding trusted persons based on a product purchase, according to one example embodiment.

FIG. 13 is a block diagram illustrating an example of a software architecture that may be installed on a machine, according to some example embodiments.

FIG. 14 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a system, as described herein, determines trusted persons for a user, records interactions with the trusted persons, and in response to the user purchasing a product, determines whether a trusted person recommended the product to the user and rewards the trusted person. In other example embodiments, the system apportions an incentive associated with the purchase of a product among several trusted persons that recommended the product.

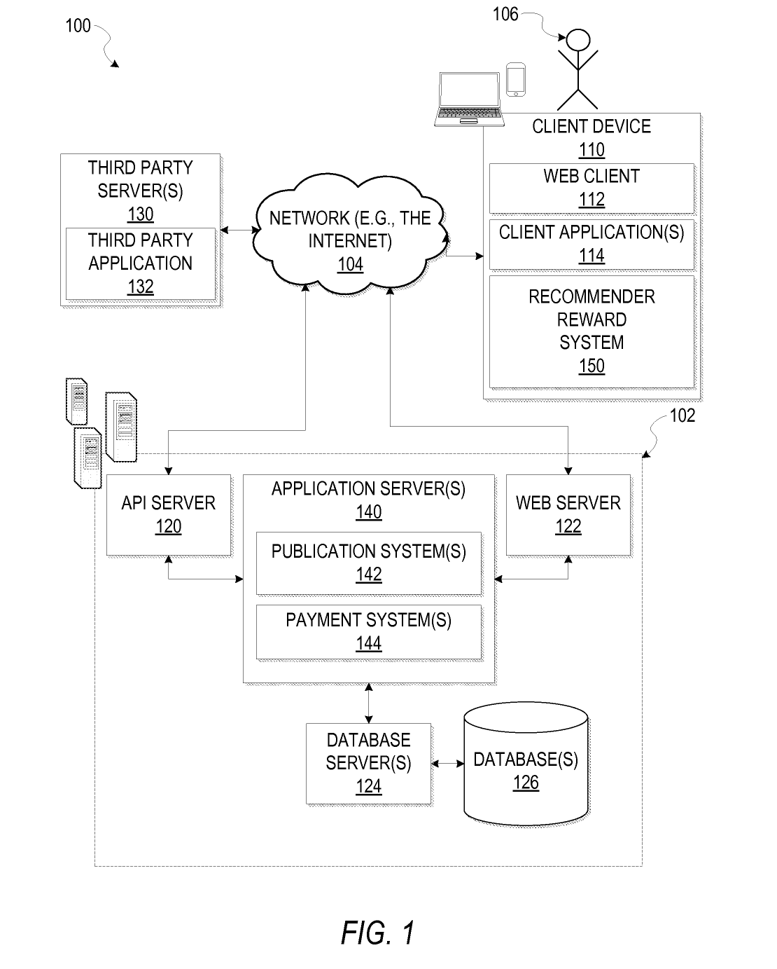

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Washington State), client application(s) 114, and a recommender reward system 150 as will be further described, executing on the client device 110.

The client device 110 may comprise, but is not limited to, a mobile phone, desktop computer, laptop, portable digital assistant (PDAs), smart phone, tablet, ultra book, netbook, laptop, multi-processor system, microprocessor-based or programmable consumer electronics, game console, set-top box, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, gyroscope, cameras, microphone, global positioning system (GPS) device, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. In one example embodiment, the recommender reward system 150 determines that the user purchased an item at the network-based marketplace using the web client 112.

One or more users 106 may be a person, a machine, or other means of interacting with the client device 110. In embodiments, the user 106 is not part of the network architecture 100, but may interact with the network architecture 100 via the client device 110 or another means. For example, one or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application server(s) 140. The application server(s) 140 may host one or more publication system 142 and payment system 144, each of which may comprise one or more modules or applications and each of which may be embodied as hardware, software, firmware, or any combination thereof. The application server(s) 140 are, in turn, shown to be coupled to one or more database servers 124 that facilitate access to one or more information storage repositories or database(s) 126. In an example embodiment, the database(s) 126 are storage devices that store information to be posted (e.g., publications or listings) to the publication system(s) 142. The database(s) 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system(s) 142 may provide a number of publication functions and services to users 106 that access the networked system 102. The payment system(s) 144 may likewise provide a number of functions to perform or facilitate payments and transactions. While the publication system(s) 142 and payment system(s) 144 are shown in FIG. 1 to both form part of the networked system 102, it will be appreciated that, in alternative embodiments, each system 142 and 144 may form part of a payment service that is separate and distinct from the networked system 102. In some embodiments, the payment system(s) 144 may form part of the publication system(s) 142.

The recommender reward system 150 may provide functionality operable to reward trusted persons (e.g., recommenders) that recommended a product to a user, based on the user purchasing a product. In certain example embodiments, the recommender reward system 150 determines one or more trusted persons for a user. The trusted persons may include persons in a relationship with the user.

In other example embodiments, the recommender reward system 150 monitors interactions between the user and persons identified as trusted persons. The interactions include, but are not limited to, emails, texts, links, received images from the trusted person, voice mails, voice calls, verbal interaction, sharing use of an eventually purchased product, the user scanning a product code for a matching product used by the trusted person, the trusted person and the user being co-located beyond a threshold period of time, the trusted person purchasing the product before the user, and a connection at a social network.

In one example embodiment, the recommender reward system 150 determines that the user purchased a product by monitoring interactions between the client device 110 and the networked system 102. For example, if a user scans a barcode for a product at a trusted person's residence, and subsequently purchases the product, the recommender reward system 150 rewards the trusted person because of a causal link between scanning the product at the trusted person's residence and purchasing the product.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system(s) 142, payment system(s) 144, and recommender reward system 150 could also be implemented as standalone software programs, which do not necessarily have networking capabilities.

The web client 112 may access the various publication and payment systems 142 and 144 via the web interface supported by the web server 122. Similarly, the recommender reward system 150 may communicate with the networked system 102 via a programmatic client. The programmatic client accesses the various services and functions provided by the publication and payment systems 142 and 144 via the programmatic interface provided by the API server 120. The programmatic client may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client and the networked system 102.

Additionally, a third party application(s) 132, executing on a third party server(s) 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

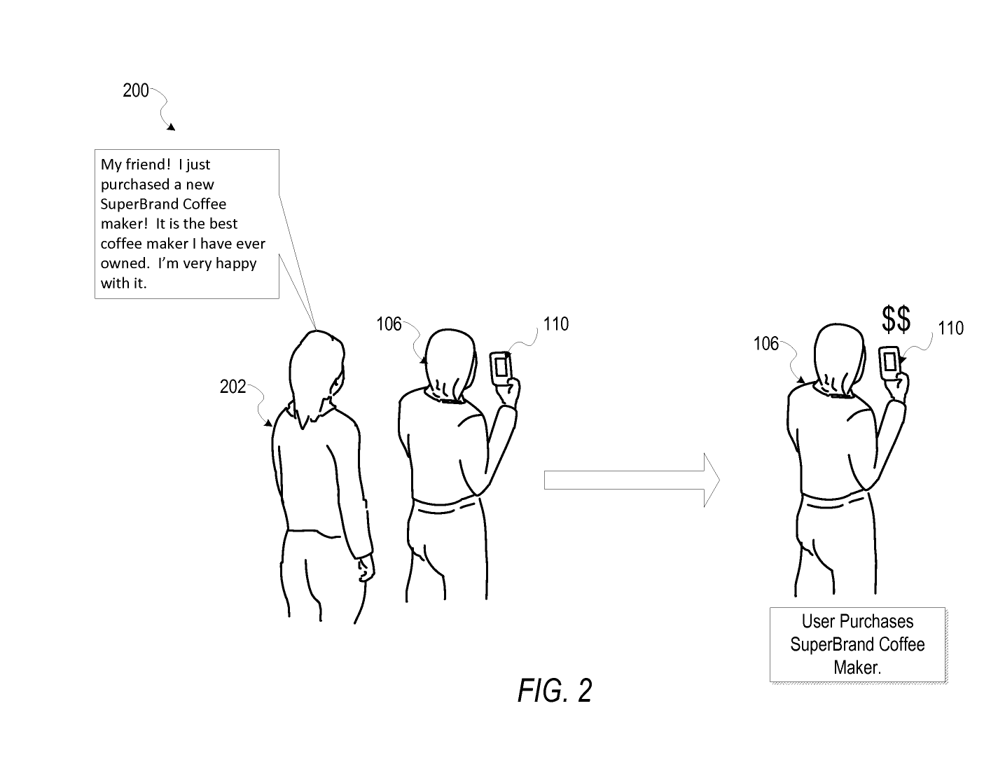

FIG. 2 is an illustration depicting one scenario 200 for determining a trusted person, according to one example embodiment. In this scenario 200, the user 106 is engaged in a casual conversation with a trusted person 202.

The recommender reward system 150 previously established the person 202 as a trusted person as will be further described. The recommender reward system 150 may have also determined that the user 106 and the trusted person 202 are co-located based, at least in part, on location capabilities for a computing device associated with the trusted person 202. In another example, the recommender reward system 150 recognizes the voice of the trusted person 202.

As the trusted person 202 expresses an opinion regarding the “SuperBrand” coffee maker, the recommender reward system 150 records the conversation and determines that the trusted person 202 recommended the product based on a verbal expression. At a later time, the recommender reward system 150 determines that the user 106 purchased the “SuperBrand” coffee maker. Because the trusted person 202 recommended the product, and the user 106 purchased the product, the recommender reward system 150 rewards the trusted person 202.

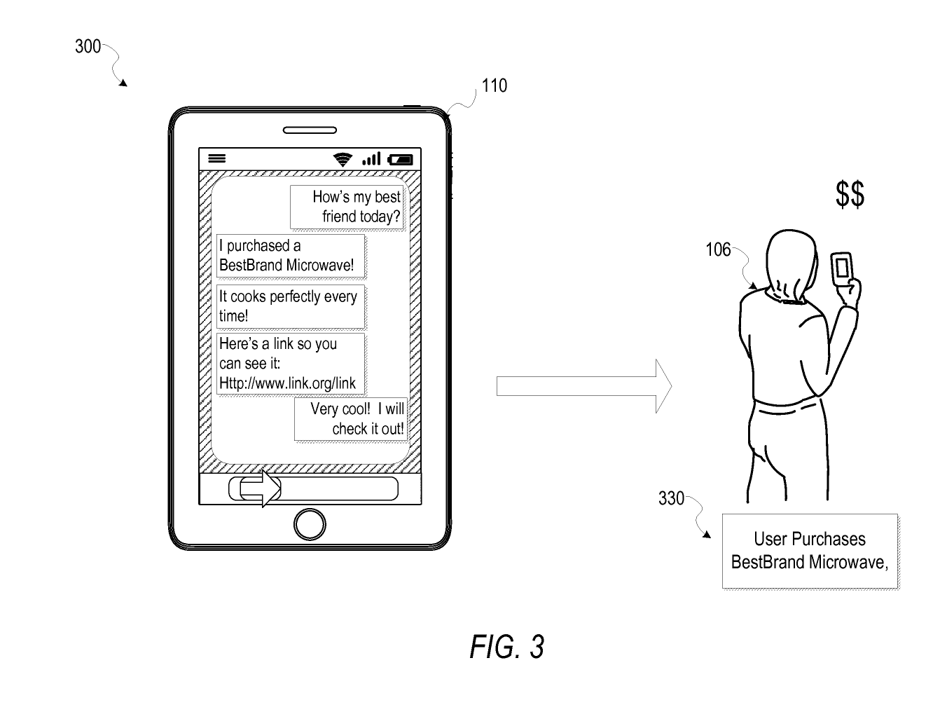

FIG. 3 is an illustration depicting another scenario for determining a trusted person, according to one example embodiment. In this scenario 300, the user 106 transmits and receives text messages from a trusted person. In one example, the recommender reward system 150 determines that the trusted person is “trusted” based on the text messages. For example, where a number of text messages exceed a threshold text message rate, the recommender reward system 150 determines that the trusted person is “trusted.” In one specific example, a threshold message rate is 10 messages per day, and in response to another person sending or receiving more than 10 messages per day to/from the user 106, the recommender reward system 150 determines that the other person is a trusted person.

In this scenario 300, the text messages also include a recommendation for the product “BestBrand Microwave.” In one example, the recommendation is a positive indicator of satisfaction. In another example, the recommendation is a link to a description of the product.

In response to the user 106 receiving a recommendation via the client device 110, and the user 106 purchasing the product (e.g. a “BestBrand Microwave”), the recommender reward system 150 transmits a reward associated with purchase of the product to the trusted person because the recommender is a trusted person and recommended the product to the user 106.

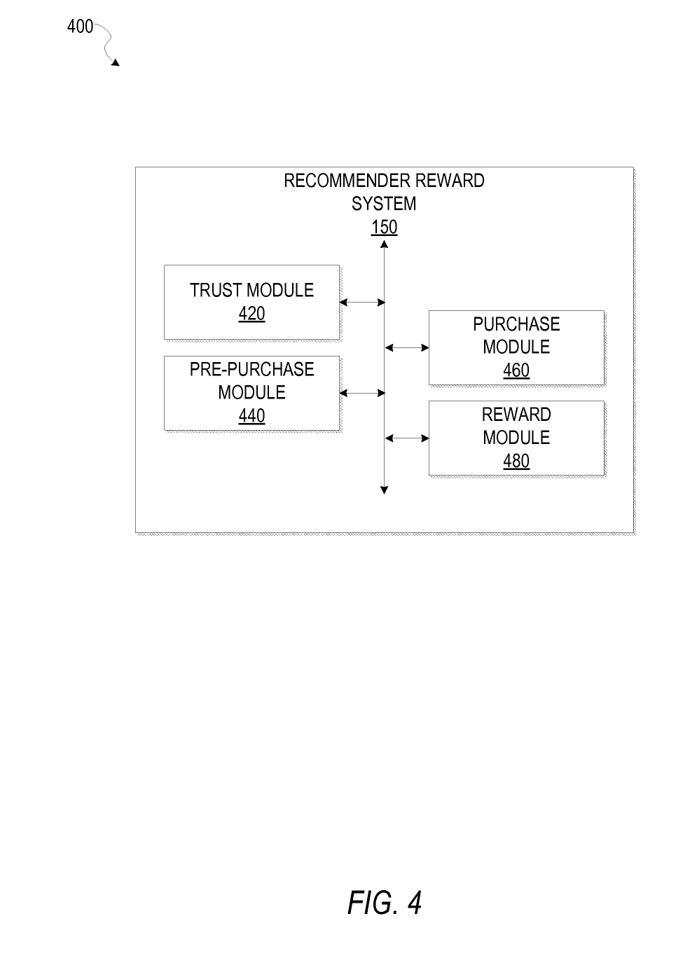

FIG. 4 is a block diagram illustrating a system 150 for rewarding trusted persons based on a product purchase, according to one example embodiment. In this example embodiment, the system 150 includes a trust module 420, a pre-purchase module 440, a purchase module 460, and a reward module 480.

The trust module 420, in one example embodiment, is configured to determine one or more trusted persons where a relationship exists between the trusted person and the user 106. In certain embodiments, a relationship includes, but is not limited to, a biological relationship, a legal relationship, an employment relationship, or other, or the like. In some examples, trusted persons may include family members, marriage partners, intimate partners, work associates, friends, acquaintances or any other persons where a connection exists between the user and the trusted person.

In other embodiments, the relationship is based on at least one of the trusted person and the potential purchaser sharing usage of a computing device, the trusted person being co-located with the potential purchaser beyond a threshold period of time, data transmitted between the trusted person and the potential purchaser exceeding a threshold amount, a device associated with the potential purchaser identifying a voice of the trusted person, a familial relationship between the trusted person and the potential purchaser, communications between the trusted person and the potential purchaser exceeding a threshold period of time, and a connection between the trusted person and the potential purchaser at a social network. Of course, one skilled in the art may recognize other ways in which a trusted person and a potential purchase may be connected and this disclosure is not limited in this regard.

In one example embodiment, the trust module 420 determines that a person is a trusted person based on the person using the user's computing device (e.g. client device 110). For example, where the trusted person logs in to the client device 110, the trust module 420 determines that the person who logged in to the client device 110 is a trusted person.

In another example embodiment, the trust module 420 determines that a person is trusted based on a threshold amount of data being transferred between the client device 110 and a computing device for the trusted person. In one example, a threshold amount of data is 50 Mebibyte (MiB). In this example, in response to either the person transmitting 50 MiB of data to the client device 110, or the user 106 transmitting 50 MiB of data to a computing device for the person, the trust module 420 determines that the person is trusted.

In another example embodiment, the threshold amount of data is an amount of data per unit time. For example, the threshold amount of data may be 10 MiB of data over a period of a week. In another example, the threshold amount of data may be 1 MiB each day for a threshold number of days. Of course, other measurements of data transfer may be used as one skilled in the art may appreciate and this disclosure is not limited in this regard.

In another example embodiment, the trust module 420 determines that the person is trusted based on recognizing the voice of the person. As one skilled in the art may appreciate, the client device 110 may be configured to recognize a voice for one or more persons and in response to the client device 110 identifying the voice of the person, the trust module 420 determines that the person is trusted.

In one example embodiment, the trust module 420 determines that the person is trusted based on a familial relationship existing between the user 106 and the person. For example, in response to determining that the person is a parent, sibling, adopted family member, extended family member, ancestor, progeny, or other, or the like, the trust module 420 determines that the person is trusted.

In another example embodiment, the trust module 420 determines that the person is trusted based on a communication time between the user 106 and the person exceeding a threshold amount of time. In one example, a threshold period of time is one hour. In response to the user 106 communicating with the person for more than one hour, the trust module 420 may determine that the person is trusted. In another example, the threshold period of time is per unit time. For example, the threshold period of time per unit time is one hour per week. In this example, in response to the user 106 and the person communicating with each other for more than one hour in a given week, the trust module 420 determines that the person is trusted.

In certain example embodiments, communicating with the person includes audio communication either via a phone line or digitally, video communication, such as video conferencing, sending text based messages, or any other communication between the user 106 and the person as one skilled in the art may appreciate.

In another example embodiment, the trust module 420 determines that the person is trusted based on a connection between the user 106 and the person at a social network. For example, a social network may allow various members of the social network to be identified as friends, family, work associates, teammates, leaders, followers, comrades, followers, or the like. In response to the user 106 and the person both being members of the social network and the social network indicating such a connection between the user 106 and the person, the trust module 420 determines that the person is trusted.

In another example, the trust module 420 determines that the person is trusted based on the person having a connection with a trusted person. For example, where the user 106 is connected with a trusted person via a social network, the trust module 420 may also include each social connection with the trusted person as a trusted person. In one example, the trust module 420 receives an indicator whether to include such bridge persons as trusted persons. In another example, the trust module 420 receives an indicator indicating how many bridges the trust module 420 may traverse to identify trusted persons.

In another example embodiment, the trust module 420 determines that the person is trusted based on the user 106 and the person being co-located beyond a threshold period of time. In one example, a threshold period of time is 4 hours. In response to the user 106 and the person being co-located beyond 4 hours, the trust module 420 determines that the person is trusted. Of course, other time periods may be used and this disclosure is not limited in this regard.

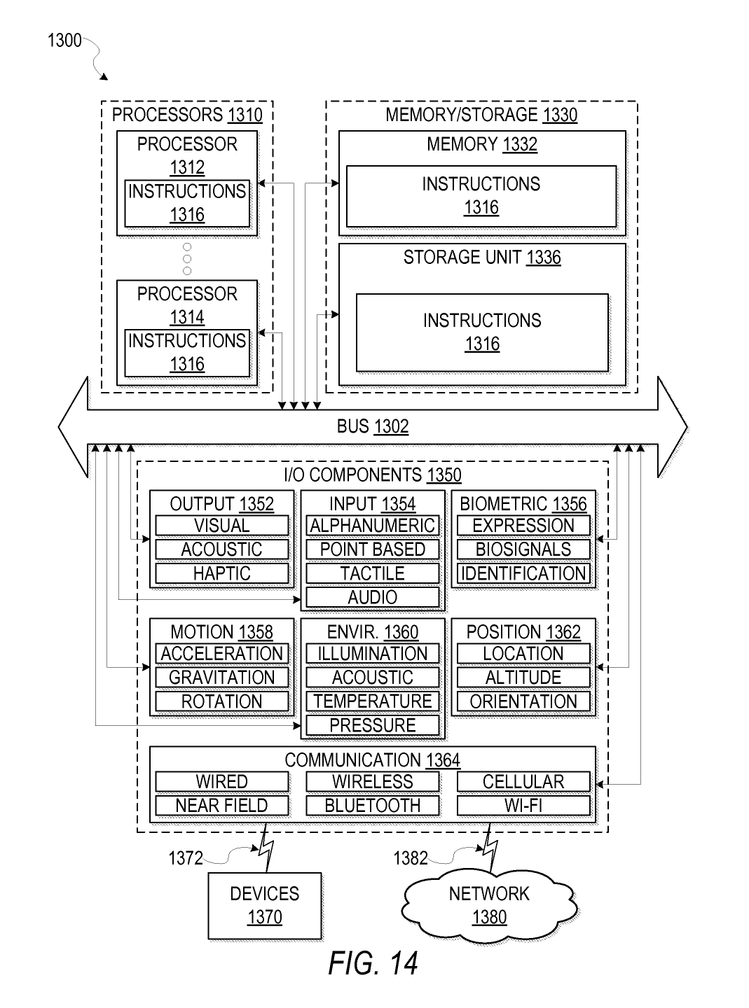

In one example embodiment, the trust module 420 determines that the person is trusted based on the user 106 being at the person's residence. In one example, the person is a user of the networked system 102 and a profile for the person indicates the residence of the person. Furthermore, the client device 110 may include one or more position sensors (e.g., 1362 of FIG. 14) and the trust module 420 determines that the user 106 is located at the person's residence. In response, the trust module 420 determines that the person is trusted.

In another example embodiment, the trust module 420 assigns varying levels of trust to different trusted persons. For example, as the user's interactions with the person increase, the trust module 420 may proportionally increase the trust level for the user 106. For example, as communication with a person exceeds a threshold value, the trust module 420 identifies the person as trust level 1. As communication with the person doubles the threshold value, the trust module 420 may identify the person as trust level 2. Accordingly, as a user's 106 interactions with the person continue, the trust level may also increase.

In another example embodiment, the trust module 420 stores trusted persons in classifications. For example, the trust module 420 stores people that are trusted based on being family members with the user 106 in a “family” classification. In other examples, classifications of trusted persons includes, but are not limited to, work associates, friends, acquaintances, neighbors, religious group members, classmates, or other, or the like. The reward module 480, in one example embodiment, alters the reward to the trusted person based on the classification.

In one example embodiment, the pre-purchase module 440 is configured to record interactions between the purchaser and the trusted persons. The pre-purchase module 440 may also store in interactions in a log of historical interactions.

In one example embodiment, the pre-purchase module 440 determines that the user 106 scanned a product code for a product purchased by the trusted person. In one example, a camera operating at the client device 110 is directed by the user 106 to capture an image. The pre-purchase module 440 may determine whether the image includes a product code of a product as one skilled in the art may appreciate. Furthermore, the pre-purchase module 440 may determine that the trusted person had purchased the product by requesting purchase records of the trusted person by the networked system 102. Of course, one skilled in the art may recognize other ways in which the pre-purchase module 440 may determine that the trusted person had purchased the product.

In another example embodiment, the pre-purchase module 440 determines that the user 106, via the client device 110, received an image of the product from a trusted person. In one example, as the client device 110 receives an image as one skilled in the art may appreciate, the pre-purchase module 440 analyzes the image to determine whether a product is included in the image. As one skilled in the art may appreciate, a variety of image processing algorithms may be applied to determine whether a product is included in an image. Accordingly, the pre-purchase module 440 stores an entry in the historical log indicating that the user 106, via the client device 110, received an image of a product from the trusted person.

In one example embodiment, the pre-purchase module 440 determines that the user 106 and the trusted person are concurrently using a product. In one example, the pre-purchase module 440 determines that the user 106 and the trusted person are using a blender together based, at least in part, on: 1) the user 106 and the trusted person being co-located, 2) the user 106 and the trusted person verbally communicating regarding the blender, and 3) the user 106 and the trusted person discussing the blender. In another example, the pre-purchase module 440 determines that the user 106 and the trusted person are driving in a car together while discussing various features and/or properties of the car. This determination is based on the user 106 and the trusted person being co-located and moving along a road above a threshold speed. In another example, this determination is made based on both a computing device for the user 106 and a computing device for the trusted person communicating with a computing device for the car.

In one specific example, the user 106 and the trusted person may be at an apartment concurrently and the pre-purchase module 440 may add an entry in a log of historical interactions. In response to the user 106 subsequently renting the apartment, the reward module 480 rewards the trusted person. In one example, the pre-purchase module 440 determines that the user 106 and the trusted person are concurrently using the product based on a beacon at the location of the product detecting the client device 110 and a computing device for the trusted person at a similar point in time.

In another example embodiment, the pre-purchase module 440 determines that the trusted person verbally recommended the product to the user 106. In one example, as previously described, the pre-purchase module 440 receives an audio signal from an ambient microphone at the client device 110. The pre-purchase module 440 may recognize the voice of the trusted person. The pre-purchase module 440 may also transcribe what the trusted person is saying. In response to the trusted person recommending a product, the pre-purchase module 440 stores an entry in the log of historical interactions that the trusted person recommended the product.

In another example embodiment, the pre-purchase module 440 determines that the trusted person indicates a preference for the product at a remote service. In one example, the trusted person gave the product a high rating at a social network. For example, the trusted person may have given the product a rating of 4 of 5 stars. Of course, one skilled in the art may appreciate a wide variety of different ways in which a trusted person may indicate preference for a product at a remote server.

In another example embodiment, the user 106 receives a link to the product from a trusted person via the client device 110. For example, the pre-purchase module 440 monitors chat messages, emails, and other media content that could include a link. In response to receiving media content via the client device 110, the pre-purchase module 440 determines that the trusted person recommended the product. The pre-purchase module 440 may then store an entry in a historical log of interactions that describes the recommendation. In one example, the entry includes a date and time for the interaction, the trusted person, the product, the link, or the like.

In one example embodiment, a recommendation received from a trusted person, in the variety of different ways described herein, also includes a location of where to purchase the item, a cost of the item, and other purchase-related information. In another example embodiment, recommendation meta-data includes an identity of the trusted person. In this way, the reward module 480 more easily identifies the trusted person to reward in response to the user 106 purchasing the item as recommended in the recommendation.

In another example embodiment, the user 106 purchases the product while located at the trusted person's residence. In response, the pre-purchase module 440 adds add an entry to the log of historical interactions that indicates the location of the purchase. In one example, the user 106 purchases the product using the client device 110 by communicating with the networked system 102. In another example, the user 106 purchases the product after traveling to the city, county, state, or other locate of the trusted person.

In another example embodiment, the purchase module 460 is configured to determine that the user 106 purchased the recommended product. In one example, the purchase module 460 monitors client application(s) 114 executing on the client device 110. In response to an application indicating that the user 106 purchased an item, the purchase module 460 determines that the user 106 purchased the item.

In one example embodiment, the user 106 purchases an item that matches the item. For example, the trusted person purchased a Ford Escort™ automobile, and recommends the automobile to the user 106. Of course, the user 106 can no longer purchase the exact automobile, but may purchase an automobile that matches the automobile purchased by the trusted person (e.g., another Ford Escort). Therefore, in certain embodiments, the user 106 purchases an item that matches the item recommended by the trusted person.

In one example, a matching item includes an exact match of the item. In other examples, a matching item is an item with the same model number, but may have different characteristics. For example, the product may be the same, but may be a different color, size, condition, or the like. The matching item may also have other selectable options that differ from the recommended item. Therefore, it is not necessary that the matching item is an exact match but is similar enough that one skilled in the art would believe they are from a same manufacturer.

In one example embodiment, the reward module 480 is configured to determine one of the trusted persons that recommended the product to the user 106 in an interaction stored in the log. The reward module 480 rewards the trusted person that recommended the product to the user 106. The reward may include, but is not limited to, a purchase incentive, a rebate, a finder's fee, a commission, a benefit, a coupon, an item, a service, or any other benefit as one skilled in the art may appreciate. In one example, the reward is a percentage commission and the reward module 480 transmits the percentage commission to the trusted person that recommended the product to the user 106.

In another example embodiment, two or more trusted persons recommended the product to the user 106 and the reward module 480 selects the trusted person to receive the reward that recommended the product to the user 106 a higher number of times. In one example, a first trusted person X recommended the product to the user 106 eight times and a second trusted person Y recommended the product to the user 106 four times; the reward module 480 selects the first trusted person X because of a higher number of recommendations.

In another example embodiment, the reward module 480 partitions the reward among two or more trusted persons that recommended the product. In one specific, non-limiting example, a first trusted person C recommended the product to the user 106 four times, a second trusted person recommended the product to the user 106 three times, and a third trusted person recommended the product to the user 106 three times. Accordingly, the reward module 480 may divide the reward among the trusted recommenders according to their respective recommendations. In this specific example, the first trusted recommender receives 40% of the reward, the second trusted recommender receives 30% of the reward, and the third trusted recommender receives 40% of the reward, according to their respective percentage of the recommendations for the product.

In another example embodiment, the reward module 480 rewards the most recent trusted person. In one example, a first trusted person recommends the product to the user 106 five different times and a second trusted person recommends the product to the user 106 a single time, but after each of the five recommendations from the first trusted person. In response to the user 106 purchasing the item, the reward module 480 rewards the second trusted person because the recommendation from the second trusted person was most recent.

In one example embodiment, the reward module 480 determines which trusted person to reward by scanning the log of historical interactions. In this example, the log of historical interactions is very long and includes interactions for the past several years. In response to the user 106 purchasing a very expensive item, the reward module 480 scans the entire log; however, in response to the user 106 purchasing an inexpensive item, the reward module 480 may scan only the most recent entries in the log of historical interactions.

In one example, the recommended product is an automobile. In response to the user 106 purchasing an automobile (an expensive item), the reward module 480 completely scans the log. In another example, the recommended product is a board game. In response to the user 106 purchasing a board game, the reward module 480 scans a limited portion of the log based, at least in part, on the value of the purchased item. For example, in response to the purchased item exceeding $20,000, the reward module 480 scans each entry in the log of historical interactions. In another example, in response to the value of the purchased product being below $500, the reward module 480 scans entries in the log for the past month.

In another example, the reward module 480 rewards a trusted recommender in response to the value of the purchased recommended item being above a threshold value. In this example, the reward module 480 does not reward trusted persons in response to the value of the recommended product being below the threshold amount. For example, the recommended item may be a toothbrush. Because the value of the toothbrush falls below $5, the reward module 480 may not determine a trusted recommender and reward him/her.

In another example embodiment, the reward module 480 rewards as many trusted recommenders as possible by specifying a minimum reward. In one example, the minimum reward is $1, and in response to the user 106 purchasing a recommended product for $100, the reward module 480 rewards the most recent 100 trusted recommenders by rewarding each of the most recent 100 trusted recommenders $1 each.

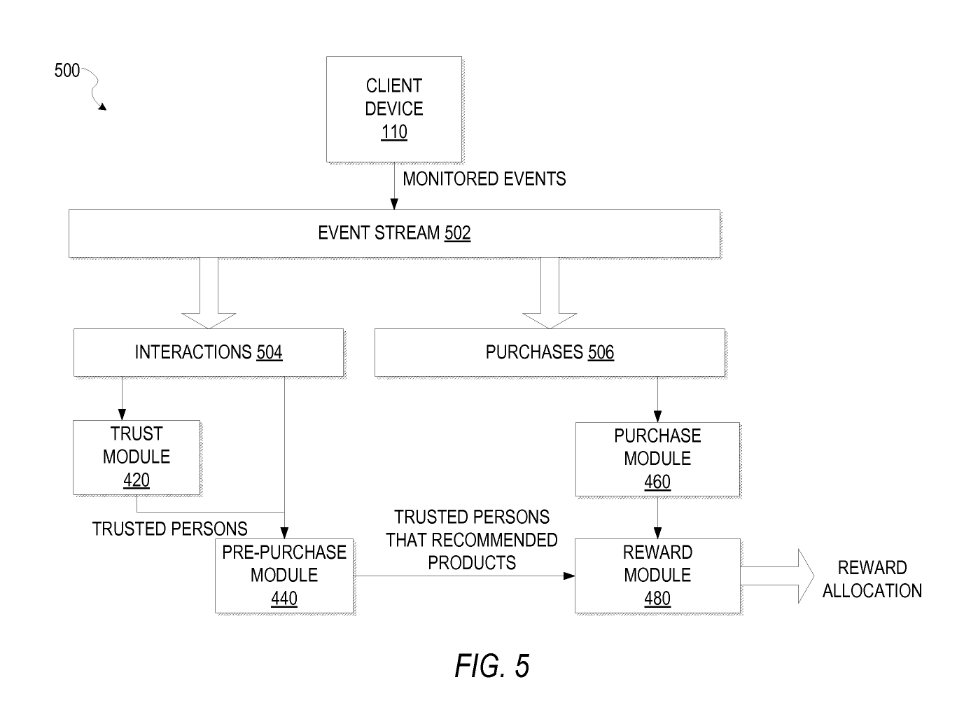

FIG. 5 is a block diagram illustrating data flow for a system that rewards trusted persons based on a product purchase, according to one example embodiment. In one example embodiment, the data flow diagram 500 depicts data flow through various modules operating as part of the client device 110.

As the user 106 interacts with the client device 110, using various applications as one skilled in the art may appreciate, the modules described in FIG. 4 may recognize events in an event stream 502 occurring at the client device 110. This event stream 502 includes, but is not limited to, interactions 504 and purchases 506. The interactions 504 include, but are not limited to, received messages, transmitted messages, communications with other persons, audio recordings, transcribed conversations, received images, received links, product reviews, social network connections, or other interactions as described herein, or the like.

In one example embodiment, the events in the event stream 502 that are product purchases 506 include, but are not limited to, winning an auction at a networked system 102, purchasing an item by communicating with a networked system 102, or the like, as one skilled in the art may appreciate.

As depicted in FIG. 5, the trust module 420 receives the various interactions 504 and determines whether the interactions 504 satisfy conditions indicating whether the person is a trusted person or not. The pre-purchase module 440 also receives the stream of events that are interactions 504 and stores the interactions 504 in a historical log of interactions in response to the person involved in the interaction being a trusted person and the interactions 504 including a recommendation for a product. In response, the pre-purchase module 440 determines trusted persons that recommended one or more products.

In one example embodiment, the purchase module 460 receives events that are purchases 506 and forwards the purchase events to the reward module 480. The reward module 480 identifies the product involved in the purchase and determines whether the product was recommended by a trusted person by reading the log of historical interactions generated by the pre-purchase module 440. In response to determining that a trusted person recommended the purchased product, the reward module 480 may allocate the reward to the trusted person.

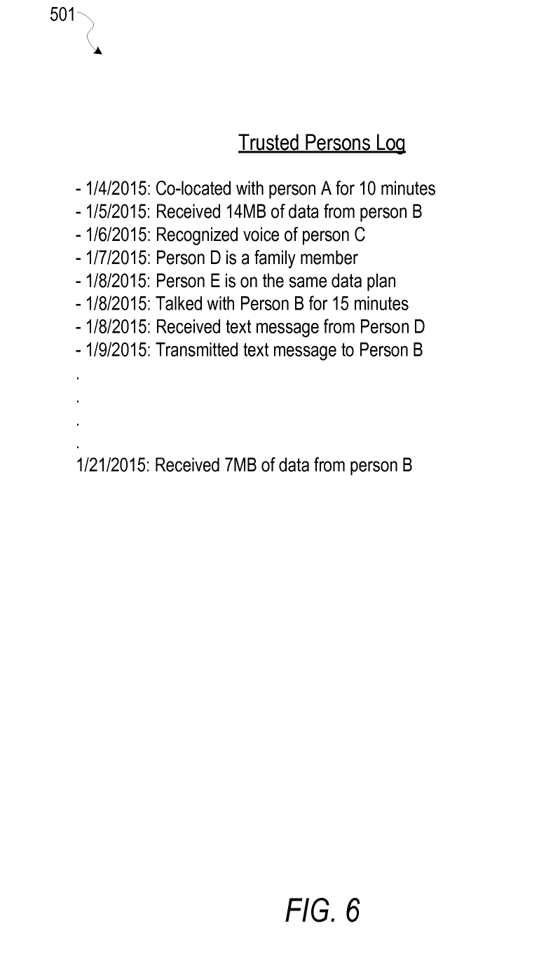

FIG. 6 is a trusted persons log 501, according to one example embodiment. This log 501 stores user 106 interactions with other persons. For example, as the trust module 420 detects interactions with other persons via the client device 110, the trust module 420 stores an entry for each interaction in the log 501.

For example, the trust module 420 determines that person A is co-located with the user 106 for a time period of 10 minutes and stores an entry in the log 501 indicating a time for the interaction and a description of the interaction. In another example embodiment, the entry in the log 501 includes a date, a time of day, a category of the interaction, and a magnitude of the interaction. In certain examples, interaction categories include co-location, data transfer, family relations, communication, or others as described herein. In other embodiments, magnitude of the interaction includes duration, amount of data, or other numerical values that describe the interaction.

The log 501 may store all interactions or may be limited to a specified amount of time. For example, the log 501 may store all interactions for the past year and may remove interactions from the log 501 that are more than a year old. This may keep the log 501 from growing too large. Of course, other time periods may be used and this disclosure is not limited in this regard.

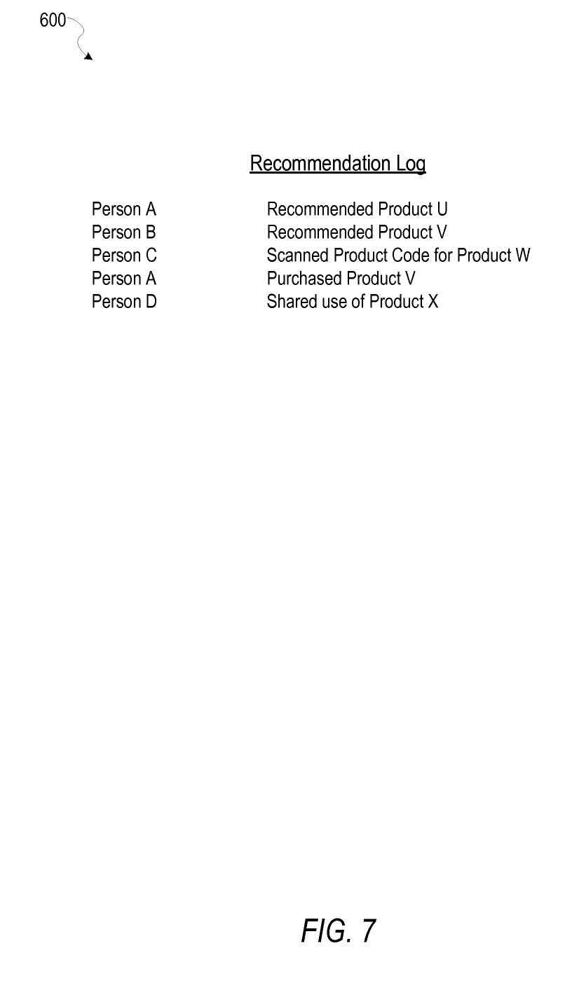

FIG. 7 is a recommendation log 600, according to one example embodiment. According to one example embodiment, the pre-purchase module 440 determines when a trusted person recommends a product as previously described. The pre-purchase module 440 may add an entry in the log each time a recommendation by a trusted person is detected. In one example, a trusted person becomes a trusted recommender in response to recommending a product to the user 106.

In one example embodiment, the log 600 is a text based on with one entry for each line in the text file. The entry may include a wide variety of fields including, but not limited to, a date of the recommendation, a time of day for the recommendation, the identity of the trusted person making the recommendation, an identification of the recommended product, a category of the recommended product, a reward associated with the recommended product, a value or price of the recommended product, or other, or the like. In another example, the log 600 is a character-delimited value file as one skilled in the art may appreciate.

In another example embodiment, the log 600 is binary in nature. In this example, each field of an entry is stored as a binary value. As one skilled in the art may appreciate, each entry may conform to a pre-determined field order and byte size for each field. Of course, a wide variety of different formats for the log 600 may be used, and this disclosure is not limited in this regard.

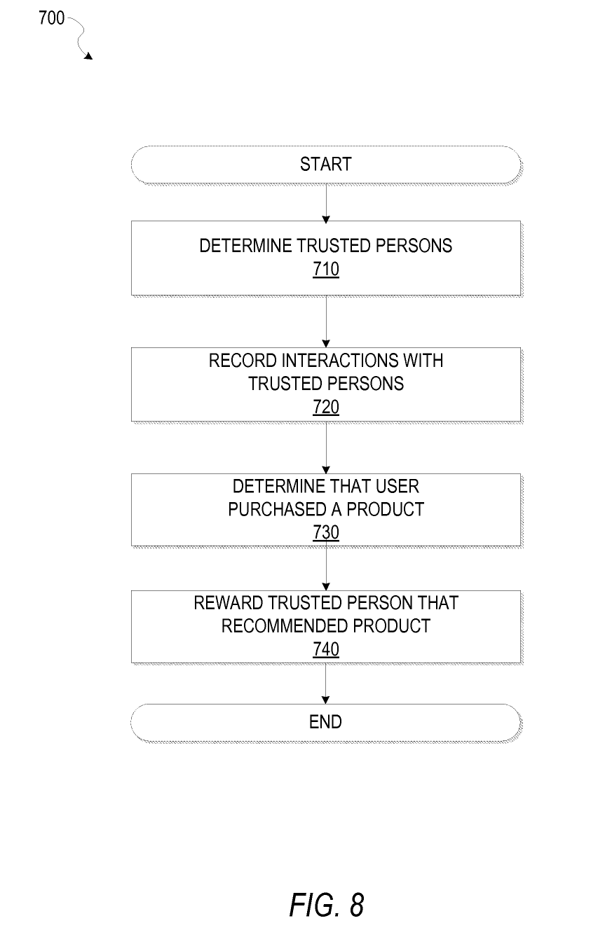

FIG. 8 is flow diagram illustrating a method 700 for rewarding trusted persons based on a product purchase, according to one example embodiment. Operations in the method 700 may be performed by the recommender reward system 150, using modules described above with respect to FIG. 4. As shown in FIG. 8, the method 700 includes operations 710, 720, 730, and 740.

In one example embodiment, the method 700 begins, and at operation 710 the trust module 420 determines one or more trusted persons where a relationship exists between the respective trusted persons and a purchaser. The method 700 continues at operation 720, and pre-purchase module 440 records interactions between the purchaser and the trusted persons. In another embodiment, the pre-purchase module 440 stores the interactions in a log of historical interactions.

The method 700 continues at operation 730 and the purchase module 460 determines that the purchaser purchased a product. The method 700 continues at operation 740 and the reward module 480 determines one of the trusted persons that recommended the product to the user 106 in an interaction stored in the log 600. The reward module 480 may then reward the trusted person that recommended the product to the purchaser.

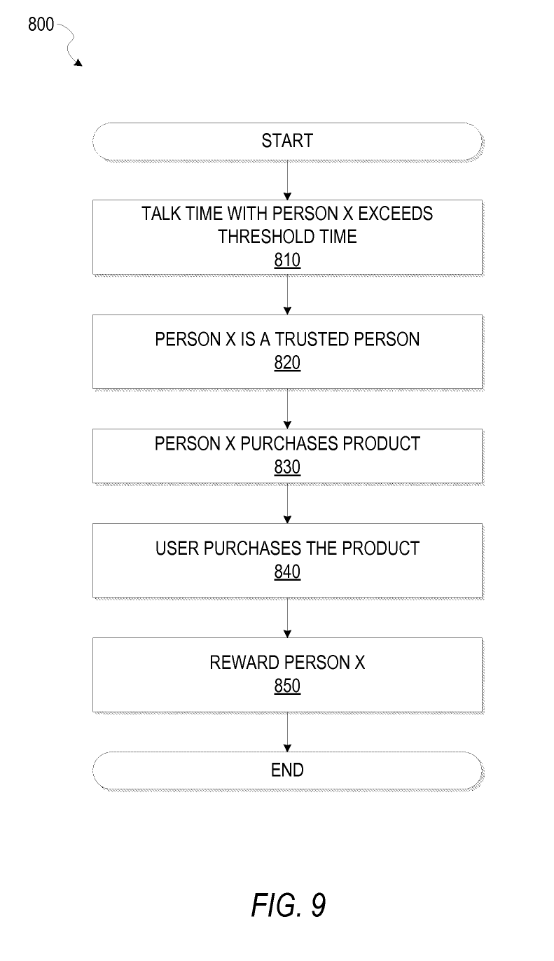

FIG. 9 is a flow diagram illustrating another method 800 for rewarding a trusted person based on a product purchase, according to one example embodiment. Operations in the method 800 may be performed by the recommender reward system 150, using modules described above with respect to FIG. 4. As shown in FIG. 8, the method 800 includes operations 810, 820, 830, 840, and 850.

In one example embodiment, the method 800 begins, and at operation 810 the trust module 420 determines that a communication time threshold between the user 106 and a person X has exceed a threshold time. In response, at operation 810, the trust module 420 determines that the person X is a trusted person. The method 800 continues and at operation 830, the pre-purchase module 440 determines that the person X purchased the product. The pre-purchase module 440 may include this information as an entry in the recommendation log 600.

The method 800 continues and at operation 840, the purchase module 460 determines that the user 106 purchased a product that matches the product purchased by the person X. The method 800 continues at operation 850 and the reward module 480 rewards the person X based on the person X purchasing the product before the user 106 purchased the product.

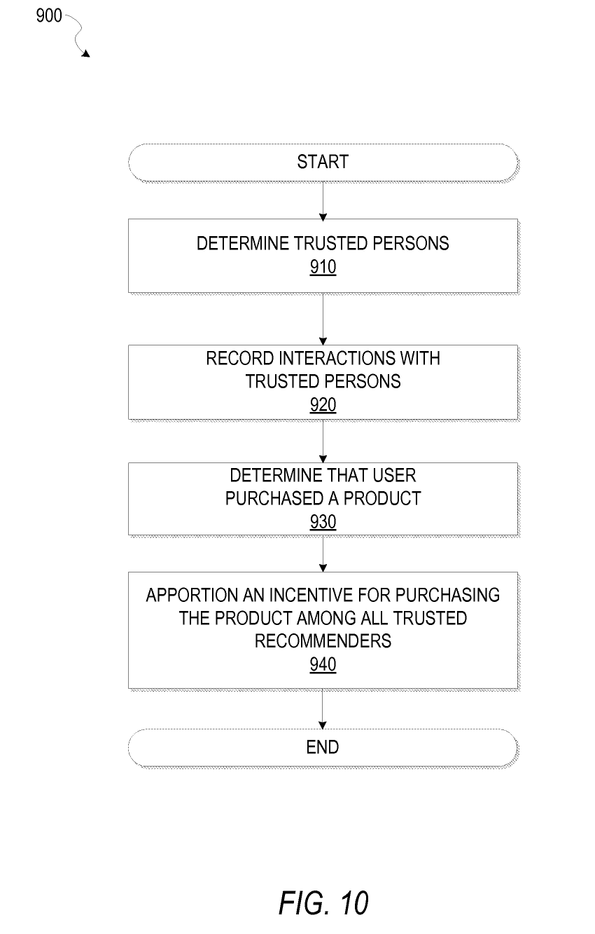

FIG. 10 is a flow diagram illustrating a method 900 for rewarding many trusted persons based on a product purchase, according to one example embodiment. Operations in the method 900 may be performed by the recommender reward system 150, using modules described above with respect to FIG. 4. As shown in FIG. 10, the method 900 includes operations 910, 920, 930, and 940.

In one example embodiment, the method 900 begins and at operation 910, the trust module 420 determines several trusted persons as described herein. The method 900 continues at operation 920 and the pre-purchase module 440 records interactions between the user 106 and the trusted persons. The method 900 continues at operation 930 and the purchase module 460 determines that the user 106 purchased a product. The method 900 continues with the reward module 480, at operation 940, apportioning the reward among all of the trusted persons that recommended the purchased product to the user 106.

In one embodiment, the reward module 480 apportions the reward evenly among each of the trusted persons that recommended the product. In another example embodiment, the reward module 480 apportions the reward among each of the trusted persons according to their respective influence indicated in the recommendation log 600.

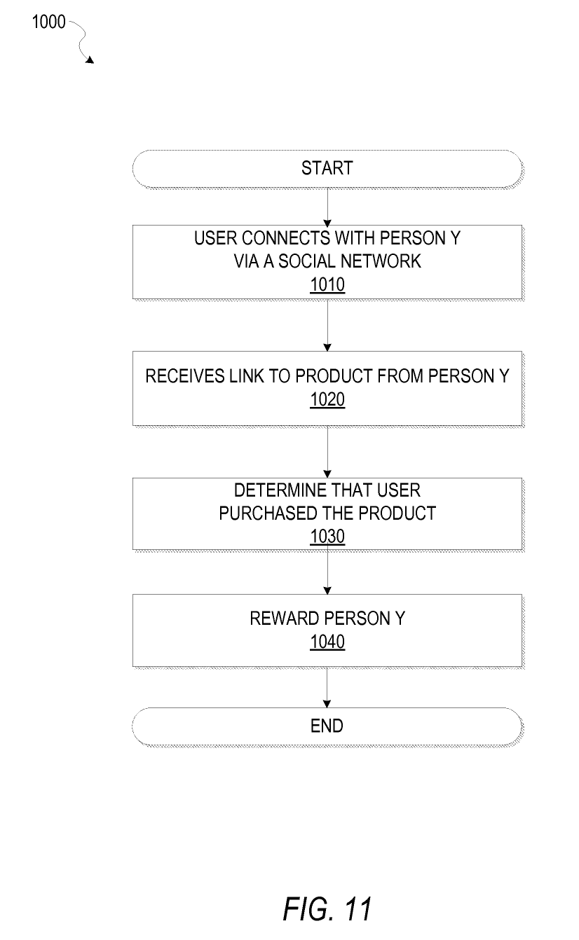

FIG. 11 is a flow diagram illustrating another method for rewarding a trusted person based on a product purchase, according to an example embodiment. . Operations in the method 1000 may be performed by the recommender reward system 150, using modules described above with respect to FIG. 4. As shown in FIG. 11, the method 1000 includes operations 1010, 1020, 1030, and 1040.

In one example embodiment, the method 1000 begins and at operation 1010 the trust module 420 determines that the user 106 connected with person Y via a social network. The method 1000 continues and at operation 1020, the pre-purchase module 440 determines that the user 106 receives a link to a product from person Y. The pre-purchase module 440 may then store the link (e.g., the recommendation), in the recommendation log 600.

The method 1000 continues and at operation 1030 the purchase module 460 determines that the user 106 purchased the recommended product. In response, the reward module 480, at operation 1040, rewards the person Y that provided the recommendation.

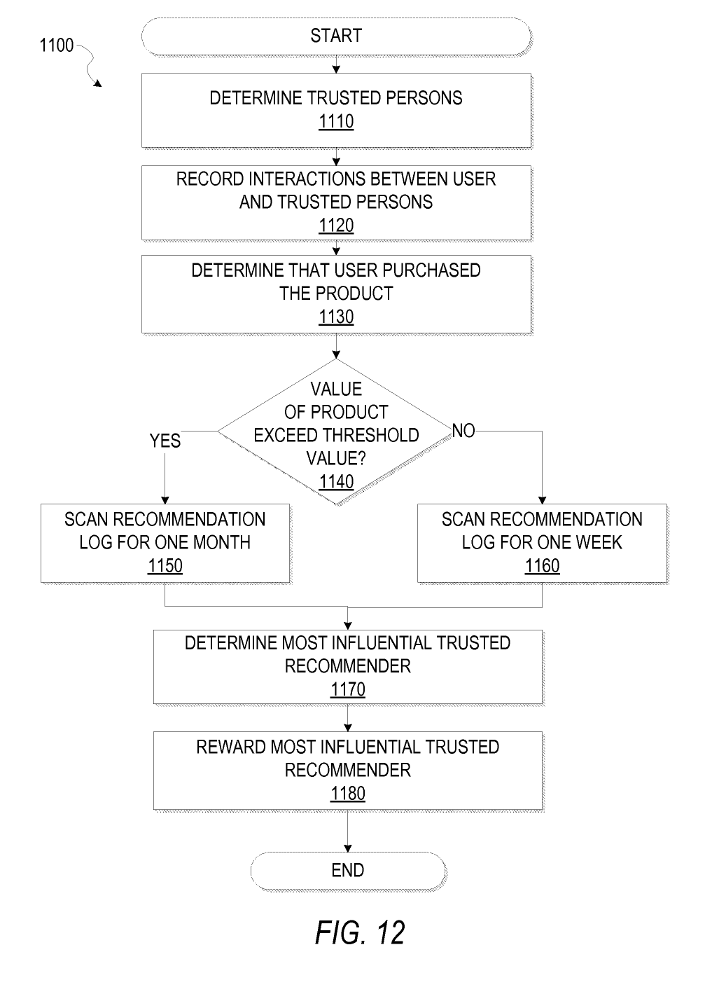

FIG. 12 is a flow diagram illustrating one method 1100 for rewarding trusted persons based on a product purchase, according to one example embodiment. Operations in the method 1100 may be performed by the recommender reward system 150, using modules described above with respect to FIG. 4. As shown in FIG. 12, the method 1100 includes operations 1110, 1120, 1130, 1140, 1150, 1160, 1170, and 1180.

In one embodiment, the method 1100 begins and at operation 1110, the trust module 420 determines one or more trusted persons that have a relationship with the user 106 as described herein. The method 1100 continues at operation 1120 and the pre-purchase module 440 records interactions between the user 106 and the trusted persons in a log of historical interactions. The method 1100 continues at operation 1130 and the purchase module 460 determines that the user 106 purchased a recommended product.

At operation 1140, the reward module 480 determines whether the value of the product exceeds a threshold value. For example, the threshold value may be $500. In response to the value of the product being above the threshold value, the method 1100 continues at operation 1150, and the reward module 480 scans the recommendation log 600 for interactions that occurred within the past month.

In response to the value of the product being at or below the threshold value, the method 1100 continues at operation 1160, and the reward module 480 scans the recommendation log 600 for interactions that occurred within the past week. In another example embodiment, the reward module 480 scans beyond a specified period of time in response to not finding a trusted recommender. The method 1100 continues at operation 1170 and the reward module 480 determines the most influential trusted recommender. The method 1100 continues at operation 1180 and the reward module 480 rewards the most influential trusted recommender.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-12 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Software Architecture

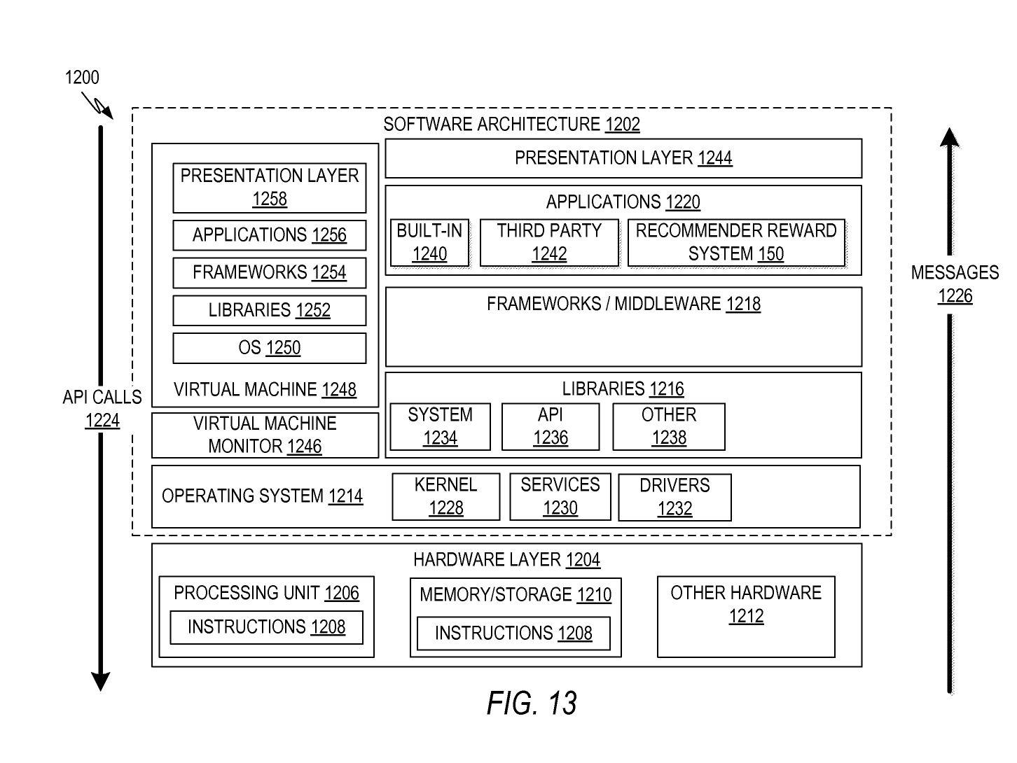

FIG. 13 is a block diagram 1200 illustrating a representative software architecture 1202, which may be used in conjunction with various hardware architectures herein described. FIG. 13 is merely a non-limiting example of a software architecture and it will be appreciated that many other architectures may be implemented to facilitate the functionality described herein. The software architecture 1202 may be executing on hardware such as machine 1300 of FIG. 14 that includes, among other things, processors 1310, memory/storage 1330, and I/O components 1350. A representative hardware layer 1204 is illustrated and can represent, for example, the machine 1300 of FIG. 14. The representative hardware layer 1204 comprises one or more processing units 1206 having associated executable instructions 1208. Executable instructions 1208 represent the executable instructions of the software architecture 1202, including implementation of the methods, modules and so forth of FIGS. 4-12. Hardware layer 1204 also includes memory and/or storage modules 1210, which also have executable instructions 1208. Hardware layer 1204 may also comprise other hardware as indicated by 1212 which represents any other hardware of the hardware layer 1204, such as the other hardware illustrated as part of machine 1300.

In the example architecture of FIG. 12, the software architecture 1202 may be conceptualized as a stack of layers where each layer provides particular functionality. For example, the software architecture 1202 may include layers such as an operating system 1214, libraries 1216, frameworks/middleware 1218, applications 1220 and presentation layer 1244. Operationally, the applications 1220 and/or other components within the layers may invoke application programming interface (API) calls 1224 through the software stack and receive a response, returned values, and so forth illustrated as messages 1226 in response to the API calls 1224. The layers illustrated are representative in nature and not all software architectures have all layers. For example, some mobile or special purpose operating systems may not provide a frameworks/middleware 1218 layer, while others may provide such a layer. Other software architectures may include additional or different layers.

The operating system 1214 may manage hardware resources and provide common services. The operating system 1214 may include, for example, a kernel 1228, services 1230, and drivers 1232. The kernel 1228 may act as an abstraction layer between the hardware and the other software layers. For example, the kernel 1228 may be responsible for memory management, processor management (e.g., scheduling), component management, networking, security settings, and so on. The services 1230 may provide other common services for the other software layers. The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1216 may provide a common infrastructure that may be utilized by the applications 1220 and/or other components and/or layers. The libraries 1216 typically provide functionality that allows other software modules to perform tasks in an easier fashion than to interface directly with the underlying operating system 1214 functionality (e.g., kernel 1228, services 1230 and/or drivers 1232). The libraries 1216 may include system libraries 1234 (e.g., C standard library) that may provide functions such as memory allocation functions, string manipulation functions, mathematic functions, and the like. In addition, the libraries 1216 may include API libraries 1236 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1216 may also include a wide variety of other libraries 1238 to provide many other APIs to the applications 1220 and other software components/modules.

The frameworks/middleware 1218 (also sometimes referred to as middleware) may provide a higher-level common infrastructure that may be utilized by the applications 1220 and/or other software components/modules. For example, the frameworks/middleware 1218 may provide various graphic user interface (GUI) functions, high-level resource management, high-level location services, and so forth. The frameworks/middleware 1218 may provide a broad spectrum of other APIs that may be utilized by the applications 1220 and/or other software components/modules, some of which may be specific to a particular operating system or platform.

The applications 1220 include built-in applications 1240 and/or third party applications 1242. Examples of representative built-in applications 1240 may include, but are not limited to, a contacts application, a browser application, a book reader application, a location application, a media application, a messaging application, and/or a game application. Third party applications 1242 may include any of the built-in applications 1240 as well as a broad assortment of other applications. In a specific example, the third party application 1242 (e.g., an application developed using the AndroidTM or iOS™ software development kit (SDK) by an entity other than the vendor of the particular platform) may be mobile software running on a mobile operating system such as iOS™, Android™, Windows® Phone, or other mobile operating systems. In this example, the third party application 1242 may invoke the API calls 1224 provided by the mobile operating system such as operating system 1214 to facilitate functionality described herein.

In certain embodiments, the recommender reward system 150 is implemented as an application 1220. In this embodiment, the trust module 420 may communicate with one or more frameworks/middleware 1218 to determine events that include user 106 interactions with other persons. In one example, the trust module 420 communicates with a social networking application to determine persons who are associated with the user 106. In another example, the trust module 420 communicates with messaging applications, other communications applications, or the like, to determine interactions with other persons.

The pre-purchase module 440, in one example, stores the trusted persons log 501 at the memory/storage modules 1210. In another example, the purchase module 460 communicates with other applications to determine that the user 106 purchased a product. For example, another application 1220 may be an online shopping application allowing the user 106 to purchase products. The purchase module 460 may request purchases made by the user 106 via the online shopping application 1220 to determine that the user 106 purchased a product. In another example embodiment, the reward module 480 communicates with other applications 1220 to determine a reward that is associated with a purchased product.

The applications 1220 may utilize built-in operating system functions (e.g., kernel 1228, services 1230 and/or drivers 1232), libraries (e.g., system libraries 1234, API libraries 1236, and other libraries 1238), frameworks/middleware 1218 to create user interfaces to interact with users of the system. Alternatively, or additionally, in some systems, interactions with a user may occur through a presentation layer, such as presentation layer 1244. In these systems, the application/module “logic” can be separated from the aspects of the application/module that interact with a user.

Some software architectures utilize virtual machines. In the example of FIG. 12, this is illustrated by virtual machine 1248. A virtual machine creates a software environment where applications/modules can execute as if they were executing on a hardware machine (such as the machine 1300 of FIG. 14, for example). A virtual machine is hosted by a host operating system (operating system 1214 in FIG. 13) and typically, although not always, has a virtual machine monitor 1246, which manages the operation of the virtual machine 1248 as well as the interface with the host operating system (i.e., operating system 1214). A software architecture executes within the virtual machine 1248 such as an operating system 1250, libraries 1252, frameworks / middleware 1254, applications 1256 and/or presentation layer 1258. These layers of software architecture executing within the virtual machine 1248 can be the same as corresponding layers previously described or may be different.

### Example Machine Architecture and Machine-Readable Medium

FIG. 14 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. For example the instructions 1316 may cause the machine 1300 to execute the flow diagrams of FIGS. 8-12. Additionally, or alternatively, the instructions 1316 may implement the trust module 420, the pre-purchase module 440, the purchase module 460 and/or the reward module 480 of FIG. 4, and so forth. The instructions 1316 transform the general, non-programmed machine into a particular machine programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1316, sequentially or otherwise, that specify actions to be taken by machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory/storage 1330, and I/O components 1350, which may be configured to communicate with each other such as via a bus 1302. In an example embodiment, the processors 1310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1312 and processor 1314 that may execute instructions 1316. The term “processor” is intended to include multi-core processors that may comprise two or more independent processors (sometimes referred to as “cores”) that may execute instructions contemporaneously. Although FIG. 13 shows multiple processors 1310, the machine 1300 may include a single processor with a single core, a single processor with multiple cores (e.g., a multi-core process), multiple processors with a single core, multiple processors with multiples cores, or any combination thereof.

The memory/storage 1330 may include a memory 1332, such as a main memory, or other memory storage, and a storage unit 1336, both accessible to the processors 1310 such as via the bus 1302. The storage unit 1336 and memory 1332 store the instructions 1316 embodying any one or more of the methodologies or functions described herein. The instructions 1316 may also reside, completely or partially, within the memory 1332, within the storage unit 1336, within at least one of the processors 1310 (e.g., within the processor's cache memory), or any suitable combination thereof, during execution thereof by the machine 1300. Accordingly, the memory 1332, the storage unit 1336, and the memory of processors 1310 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1316. The term “machine-readable medium” shall also be taken to include any medium, or combination of multiple media, that is capable of storing instructions (e.g., instructions 1316) for execution by a machine (e.g., machine 1300), such that the instructions, when executed by one or more processors of the machine 1300 (e.g., processors 1310), cause the machine 1300 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 14. The I/O components 1350 are grouped according to functionality merely for simplifying the following discussion and the grouping is in no way limiting. In various example embodiments, the I/O components 1350 may include output components 1352 and input components 1354. The output components 1352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1350 may include biometric components 1356, motion components 1358, environmental components 1360, or position components 1362 among a wide array of other components. For example, the biometric components 1356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1362 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via coupling 1382 and coupling 1372 respectively. For example, the communication components 1364 may include a network interface component or other suitable device to interface with the network 1380. In further examples, communication components 1364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a Universal Serial Bus (USB)).

Moreover, the communication components 1364 may detect identifiers or include components operable to detect identifiers. For example, the communication components 1364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1364, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1380 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1380 or a portion of the network 1380 may include a wireless or cellular network and the coupling 1382 may be a Code Division Multiple Access (CDMA) connection, a Global System for Mobile communications (GSM) connection, or other type of cellular or wireless coupling. In this example, the coupling 1382 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1316 may be transmitted or received over the network 1380 using a transmission medium via a network interface device (e.g., a network interface component included in the communication components 1364) and utilizing any one of a number of well-known transfer protocols (e.g., hypertext transfer protocol (HTTP)). Similarly, the instructions 1316 may be transmitted or received using a transmission medium via the coupling 1372 (e.g., a peer-to-peer coupling) to devices 1370. The term “transmission medium” shall be taken to include any intangible medium that is capable of storing, encoding, or carrying instructions 1316 for execution by the machine 1300, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a trust module, using at least one processor of a machine, to determine one or more trusted persons based on a relationship existing between the one or more trusted persons and a potential purchaser;
a pre-purchase module to record interactions between the purchaser and the one or more trusted persons, the pre-purchase module storing the interactions in a log of historical interactions between the potential purchaser and the one or more trusted persons;
a purchase module to determine that the potential purchaser purchased a product; and
a reward module to determine at least one of the one or more trusted persons that recommended the product to the potential purchaser in an interaction stored in the log of historical interactions, the reward module rewarding the at least one trusted person that recommended the product to the purchaser, the reward based on an actual purchase of the product by the potential purchaser.

2. The system of claim 1, wherein one of the historical interactions comprises at least one of:
the potential purchaser scanning a product code of a matching product purchased by the trusted person;
the potential purchaser receiving an image of a matching product from the trusted person;
the trusted person making a purchase of a matching product prior to the potential purchaser purchasing the product;
the trusted person and the potential purchaser concurrently using a matching product;
the trusted person verbally recommending the product to the potential purchaser;
the trusted person and the potential purchaser indicating preference for the product at a remote server;
the potential purchaser receiving a link from the trusted person to purchase the product; and
the potential purchaser purchasing the product at a location of the trusted person.

3. The system of claim 1, wherein the relationship is based on at least one of:
the trusted person and the potential purchaser sharing usage of a computing device;
the trusted person being co-located with the potential purchaser beyond a threshold period of time;
data transmitted between the trusted person and the potential purchaser exceeding a threshold amount;
a device associated with the potential purchaser identifying a voice of the trusted person;
a familial relationship between the trusted person and the potential purchaser;
communications between the trusted person and the potential purchaser exceeding a threshold period of time; and
a connection between the trusted person and the potential purchaser at a social network.

4. The system of claim 1, wherein the pre-purchase module reads a limited portion of the log based on a value of the product.

5. The system of claim 1, wherein two or more of the trusted persons recommended the product to the potential purchaser, and the trusted person is selected based on interactions between the potential purchaser and the trusted person exceeding interactions between the potential purchaser and other trusted persons.

6. The system of claim 1, wherein the incentive is partitioned among two or more of the trusted persons according to their respective interactions.

7. The system of claim 1, wherein the pre-purchase module further records verbal interactions between the potential purchaser and trusted persons in the log, the reward module determining that the trusted person influenced the potential purchaser based on one of the verbal interactions in the log.

8. The system of claim 1, wherein the incentive includes at least one of a fixed amount, a percentage of a purchase price for the product, a coupon, and a discount.

9. A method comprising:
determining, using at least one processor of a machine, one or more trusted persons where a relationship exists between the one or more trusted persons and a potential purchaser;
recording interactions between the potential purchaser and the one or more trusted persons;
storing the interactions in a log of historical interactions between the potential purchaser and the one or more trusted persons;
determining that the purchaser purchased a product;
determining at least one of the trusted persons that recommended the product to the potential purchaser in an interaction stored in the log of historical interactions; and
rewarding the at least one trusted person that recommended the product to the purchaser, the reward based on an actual purchase of the product by the potential purchaser.

10. The method of claim 9, wherein the relationship is based on at least one of:
the potential purchaser scanning a product code of a matching product purchased by the trusted person;
the potential purchaser receiving an image of a matching product from the trusted person;
the trusted person making a purchase of a matching product prior to the potential purchaser purchasing the product;
the trusted person and the potential purchaser concurrently using a matching product;
the trusted person verbally recommending the product to the potential purchaser;
the trusted person and the potential purchaser indicating preference for the product at a remote server;
the potential purchaser receiving a link from the trusted person to purchase the product; and
the potential purchaser purchasing the product at a location of the trusted person.

11. The method of claim 9, wherein the trusted person is trusted based on at least one of:
the potential purchaser and the trusted person commonly using a computing device;
data transmitted between the trusted person and the potential purchaser exceeding a threshold amount;
a device associated with the potential purchaser identifying a voice of the trusted person;
a familial relationship between the trusted person and the potential purchaser;
communications between the trusted person and the potential purchaser exceeding a threshold period of time; and
a connection between the trusted person and the potential purchaser at a social network.

12. The method of claim 9, wherein the determining comprises reading a limited portion of the log of historical interactions based on a value of the product.

13. The method of claim 9, wherein two or more of the trusted persons recommended the product to the potential purchaser and determining the trusted person is based on interactions regarding the product between the potential purchaser and the trusted person exceeding interactions regarding the product between the potential purchaser and other trusted persons.

14. The method of claim 9, further comprising partitioning the incentive among two or more of the trusted persons that recommended the product to the potential purchaser according to their respective recommendations.

15. The method of claim 9, wherein recording interactions comprises recording verbal interactions between the potential purchaser and trusted persons in the log of historical interactions, the determining comprising determining that the trusted person influenced the potential purchaser based on one of the verbal interactions in the log.

16. A non-transitory machine-readable storage medium comprising instructions that, when executed by one or more processors of a machine, cause the machine to perform operations comprising:
determining, using at least one processor of a machine, one or more trusted persons based on a relationship existing between the respective trusted persons and a potential purchaser;
recording interactions between the potential purchaser and the trusted persons in a log of historical interactions;
determining that the potential purchaser purchased a product;
determining at least one of the trusted persons that recommended the product to the potential purchaser in one of the interactions; and
rewarding the at least one of the trusted persons that recommended the product to the potential purchaser, the reward comprising an incentive associated with purchasing the product.

17. The machine-readable storage medium of claim 16, wherein the operation of determining comprises reading a limited portion of the interactions based on a value of the product.

18. The machine-readable storage medium of claim 16, wherein two or more trusted persons recommended the product to the potential purchaser and determining the at least one trusted person is based on interactions regarding the product between the potential purchaser and the trusted person exceeding interactions regarding the product between the potential purchaser and other trusted persons.

19. The machine-readable storage medium of claim 16, wherein the operations further comprise partitioning the incentive among two or more of the trusted persons according to their respective interactions.

20. The machine-readable storage medium of claim 16, wherein recording interactions comprises recording verbal interactions between the potential purchaser and trusted persons in the log, the determining comprising determining that the trusted person influenced the potential purchaser based on one of the verbal interactions in the log.
